(19) United States
(12) Patent Application Publication
(10) Pub. No.: US 2012/0206370 A1
(43) Pub. Date: Aug. 16, 2012

(54) METHOD AND APPARATUS FOR DISPLAYING KEYS OF A VIRTUAL KEYBOARD

(75) Inventor: Aleksandar IVANOVIC, Waterloo (CA)

(73) Assignee: RESEARCH IN MOTION LIMITED, Waterloo (CA)

(21) Appl. No.: 13/024,435

(22) Filed: Feb. 10, 2011

(51) Int. Cl. G06F 3/041

(52) U.S. Cl. 345/173

(57) ABSTRACT

A method and apparatus for a touch sensitive device to display a first set of keys on a first window on a display of the touch sensitive device. The touch sensitive device receives a first touch event comprising a plurality of first touch values. The touch sensitive device receives a second touch event comprising a plurality of second touch values associated with a touch detected by the touch sensitive device. The touch sensitive device displays a second set of the one or more keys on a second window of the one or more windows based at least in part on the second touch event.

### FIELD OF TECHNOLOGY

The present invention relates generally to touch sensitive devices, and more particularly to a method and apparatus for displaying output on touch sensitive devices.

### BACKGROUND

Electronic devices, including touch sensitive devices, have gained widespread use and may provide a variety of functions including, for example, telephonic, electronic messaging and other personal information manager (PIM) application functions. Touch sensitive devices include, for example, several types of mobile stations such as simple cellular telephones, smart telephones, wireless personal digital assistants (PDAs), and laptop computers with wireless 802.11 or Bluetooth™ capabilities.

Touch sensitive devices such as PDAs or smart telephones are generally intended for handheld use and ease of portability. Smaller devices are generally desirable for portability. A touch-sensitive display, also known as a touch screen display, is particularly useful on handheld devices, which are small and have limited space for user input and output. The information displayed on the touch-sensitive displays may be modified depending on the functions and operations being performed. With continued demand for decreased size of touch sensitive devices, touch-sensitive displays continue to decrease in size.

Improvements in devices with touch-sensitive displays are desirable.

### BRIEF DESCRIPTION OF THE DRAWINGS

Embodiments of the present disclosure will now be described, by way of example only, with reference to the attached figures, wherein:

FIG. 1 is a block diagram of an example of a portable electronic device in accordance with the present disclosure;

FIG. 2 is a flowchart of a method for displaying keys of a virtual keyboard on a touch sensitive device;

FIG. 3 is a diagram of a touch sensitive device configured to display output of a virtual keyboard in accordance with the disclosure;

FIG. 4 is a diagram of a touch sensitive device of FIG. 3, configured to display output of a virtual keyboard in accordance with the disclosure;

FIG. 5 is a diagram of a touch sensitive device of FIG. 3, configured to display output of a virtual keyboard in accordance with the disclosure;

FIG. 6 is a diagram of a touch sensitive device of FIG. 3, configured to display output of a virtual keyboard in accordance with the disclosure.

### DETAILED DESCRIPTION

The following describes a touch sensitive device and a method that includes displaying a first set of keys on a first window on a display of the touch sensitive device, receiving a first touch event comprising a plurality of first touch values, receiving a second touch event comprising a plurality of second touch values associated with a touch detected by the touch sensitive device, and displaying a second set of the one or more keys on a second window of the one or more windows based at least in part on the second touch event.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a touch sensitive device in the embodiments described herein. Examples of touch sensitive devices include mobile, or handheld, wireless communication devices such as pagers, cellular phones, cellular smart-phones, wireless organizers, personal digital assistants, tablet computers, laptop computers, and so forth. The touch sensitive device may also be a touch sensitive device without wireless communication capabilities, such as a handheld electronic game device, digital photograph album, digital camera, a desktop computer with a touch sensitive display, or other device.

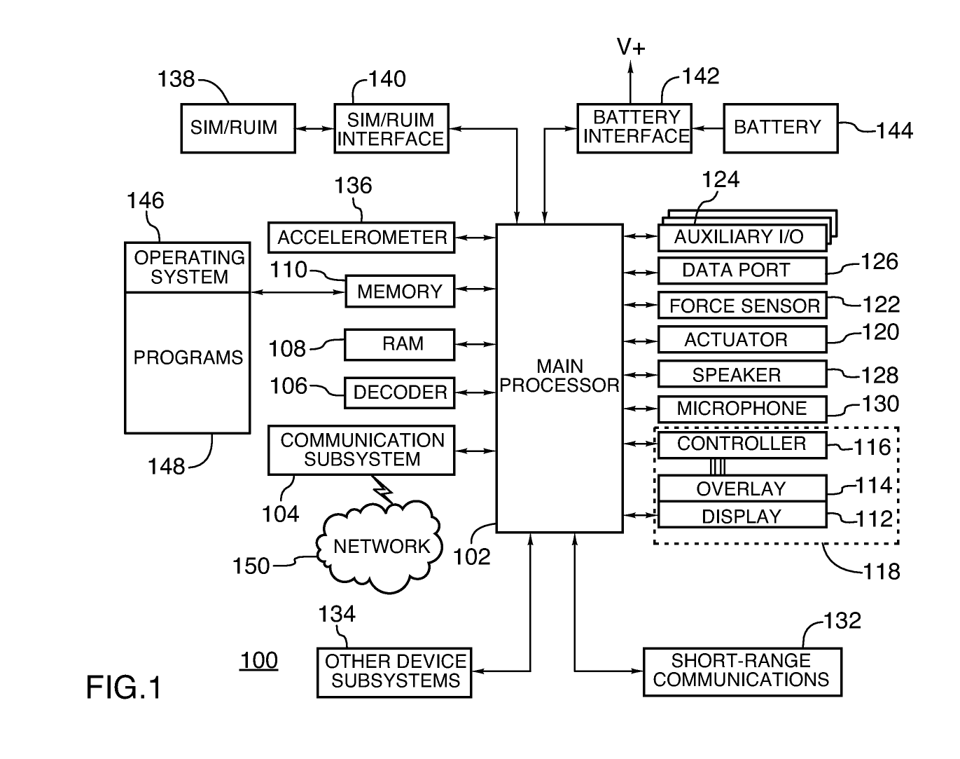

A block diagram of an example of a touch sensitive device 100 is shown in FIG. 1. The touch sensitive device 100 includes multiple components, such as a processor 102 that controls the overall operation of the touch sensitive device 100. Communication functions, including data and voice communications, are performed through a communication subsystem 104. Data received by the touch sensitive device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the touch sensitive device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, an auxiliary input/output (I/O) subsystem 124, a data port 126, a speaker 128, a microphone 130, short-range communications 132, and other device subsystems 134. The processor 102 may optionally interact with one or more actuators 120 and one or more force sensors 122. Interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a touch sensitive device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the touch sensitive device 100 uses a Subscriber Identity Module or a Removable User Identity Module (SIM/RUIM) card 138 for communication with a network, such as the wireless network 150. Alternatively, user identification information may be programmed into memory 110.

The touch sensitive device 100 includes an operating system 146 and software programs or components 148 that are executed by the processor 102 and are typically stored in a persistent, updatable store such as the memory 110. Additional applications or programs may be loaded onto the touch sensitive device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the touch sensitive device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display may include a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. The location of a detected touch may include x and y components, e.g., horizontal and vertical components, respectively, with respect to one's view of the touch-sensitive display 118. For example, the x and y components may be determined by signals generated from the touch-sensor layers, also referred to as touch sensors. A signal is provided to the controller 116 in response to detection of a touch. A touch may be detected from any suitable object, such as a finger, thumb, appendage, or other items, for example, a stylus, pen, or other pointer, depending on the nature of the touch-sensitive display 118. Multiple simultaneous touches may be detected.

The touch-sensitive display 118 is also configured to detect a gesture. A gesture, such as a swipe, is a type of touch, that begins at an origin point and continues to a finishing point while touch contact is maintained. A swipe may be long or short in distance, or duration, or both distance and duration. Two points of the swipe may be utilized to determine a vector that describes a direction of the swipe. The direction may be referenced with respect to the touch-sensitive display 118, the orientation of the information displayed on the touch-sensitive display 118, or another reference. The origin point and the finishing point of the swipe may be utilized to determine the magnitude or distance of the swipe. The processor 102 receives data from the controller 116 to determine the direction, magnitude, and duration of the swipe.

The optional actuator 120 may be depressed by applying sufficient force to the touch-sensitive display 118 to overcome the actuation force of the actuator 120. The actuator 120 may be actuated by pressing anywhere on the touch-sensitive display 118. The actuator 120 may provide input to the processor 102 when actuated. Actuation of the actuator 120 may result in provision of tactile feedback.

A mechanical dome switch actuator may be utilized. In this example, tactile feedback is provided when the dome collapses due to imparted force and when the dome returns to the rest position after release of the switch.

Alternatively, the actuator 120 may comprise one or more piezoelectric (piezo) actuators that provide tactile feedback for the touch-sensitive display 118. Contraction of the piezo actuator(s) applies a spring-like force, for example, opposing a force externally applied to the touch-sensitive display 118. Each piezo actuator includes a piezoelectric device, such as a piezoelectric disk, adhered to a substrate such as a metal substrate. The substrate bends when the piezoelectric device contracts due to build up of charge/voltage at the piezoelectric device or in response to a force, such as an external force applied to the touch-sensitive display 118. The charge/voltage may be adjusted by varying the applied voltage or current, thereby controlling the force applied by the piezo actuators. The charge/voltage at the piezo actuator may be removed by a controlled discharge current that causes the piezoelectric device to expand, decreasing the force applied by the piezo actuators. The charge/voltage may be removed over a relatively short period of time to provide tactile feedback to the user. Absent an external force and absent a charge/voltage at the piezo actuator, the piezo actuator may be slightly bent due to a mechanical preload.

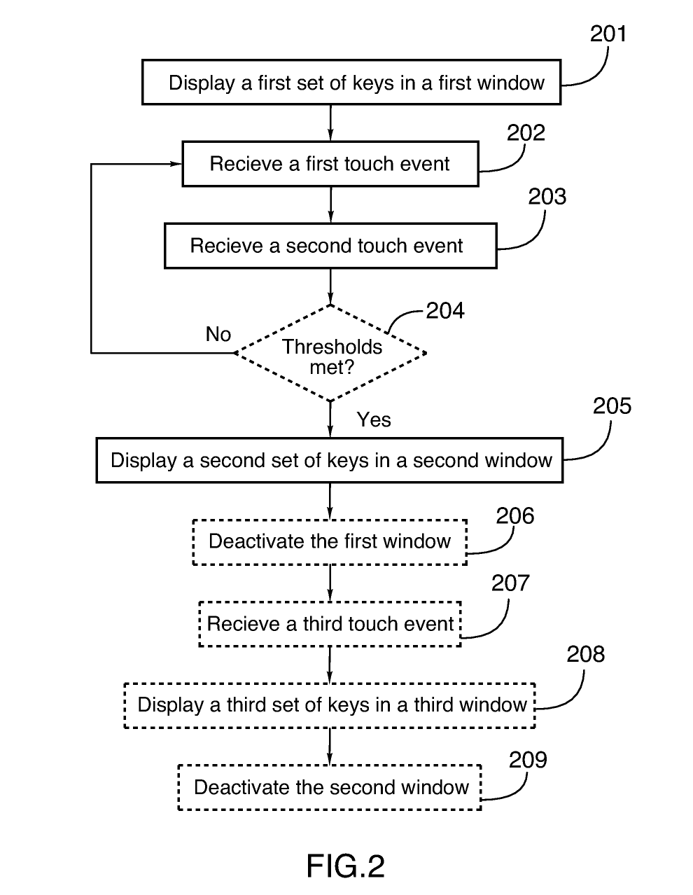

FIG. 2 is a flowchart of a method for displaying keys of a virtual keyboard on a touch sensitive device. At 201, a touch sensitive device displays a first set of one or more keys in a first window of one or more windows of a graphical user interface of the touch sensitive device.

The set of keys may be some or all of the keys of a standard keyboard layout such as a QWERTY keyboard layout or any other keyboard layout. The keys may each display one or more characters including letters, numbers, punctuation marks, and so forth. The one or more windows are visual areas on the display of the touch sensitive device allowing for interaction with applications accessible via the touch sensitive device. An application may have its output displayed onto one or more windows. The graphical user interface allows for the applications accessible via the touch sensitive device to be interacted with, for example, via the windows through the use of images on a display of the touch sensitive device in connection with touches that are detected by the touch sensitive device.

At 202, the touch sensitive device receives a first touch event that comprises a plurality of first touch values. Touch events are data structures comprising multiple values that describe the touches, gestures, and swipes detected by the touch sensitive device. As an example, a touch event may include values such as a horizontal location, a vertical location, a time, a size, a force, a type, and so forth.

The horizontal and vertical locations may be with respect to an origin of a display of the touch sensitive device, with the origin being located at any point on the display of the device. The time may be a timestamp indicating when the touch sensitive device detected a touch and generated a touch event. The size may indicate how large of an area of the touch sensitive device is detected as being touched. The force may indicate how hard or how much pressure was applied at the point of the touch detected by the device. The type may indicate a type of touch event, wherein the types include: a touch down event indicating that the touch is a new touch detected by the vice, a touch up event indicating that the touch has ended, and a move event indicating that the touch is moving.

The touch sensitive device receives touch events by one or more processors of the device receiving the touch events as signals from touch sensors or as data structures from memory or other processors. Additionally or alternatively, a touch sensitive device receives touch events by an application running on the touch sensitive device receiving the touch events, e.g., from an operating system running on the touch sensitive device.

At 203, a touch sensitive device receives a second touch event. The first touch event received at 202 may be a touch down event and the second touch event received at 203 may be a touch up or a move event. Taken together, a touch down event and a move event may indicate that the size of the virtual keyboard should be changed. Alternatively, a touch down event and a touch up event may indicate that a particular key of the virtual keyboard is selected. This is the case when the horizontal and vertical locations of the touch down and touch up events are substantially similar, e.g., when both the touch down and touch up events are associated with a same key of the virtual keyboard application.

Optionally at 204, one or more thresholds may be checked to see if they are met by differences between values of the first and second touch events. The differences between values of the first and second touch events may be above, below, or equal to a given threshold to meet that threshold. The thresholds may include a horizontal threshold, a vertical threshold, a diagonal threshold, a time threshold, and so forth. The horizontal threshold relates to the difference between the values of the horizontal locations of the first and second touch events. The vertical threshold relates to the difference between the values of the vertical locations of the first and second touch events. The diagonal threshold relates to the difference between both the values of the horizontal and the vertical locations of the first and second touch events. The time threshold relates to the difference between the times of the first and second touch events.

A difference between values of the first and second touch events may be checked against multiple thresholds. Consider the example where multiple horizontal thresholds are used. There may be a minimum horizontal threshold a maximum horizontal threshold, such that the difference between the values of the horizontal locations of the first and second touch events should be greater than the minimum horizontal threshold and less than the maxium horizontal threshold in order to be met.

When a single location threshold is used, the threshold may be on the order of 2 mm. Alternative embodiments may have one or more thresholds based on any of a size of or distance. Consider when the application is a virtual keyboard. The keys may be displayed as spaced apart by three pixels which corresponds to 2 mm. If the keyboard is resized so that the space between the keys changes then the threshold may be adjusted accordingly to change with respect to the distance between the keys.

If the one or more optional thresholds are not met, then the device may wait to receive additional touch events, such as by proceeding back to step 202. If one or more of the optional thresholds are met, then the method may continue to step 205.

At 205, a second set of the one or more keys is displayed on a second window of the one or more windows based at least in part on the second touch event. The second set of keys may include one or more keys from the first set of keys.

As an example, the second window may show one side of the virtual keyboard with the first window showing a different side of the keyboard. Hence, a left side of a QWERTY keyboard is displayed on the first window and a right side of a QWERTY keyboard is displayed on the second window.

As another example, the second window may display one or more keys that are associated with a key that is selected from the first window. This may aid in spelling words that are entered via the virtual keyboard application. In this case, the set of keys in the second window may comprise keys that are most commonly selected after the key from the first window is selected.

Optionally at 206, the first window may be deactivated. This may be in response to displaying a second window. By deactivating the first window, the set of keys displayed on the first window may no longer be selected. This deactivation may be indicated by changing the color or shading of the first set of keys or the entire first window.

Optionally at 207, the touch sensitive device may receive a third touch event. As an example, this third touch event may be associated with selecting a key on a second window that is displayed on the device.

Optionally at 208, the touch sensitive device may display a third set of keys in a third window. This may aid in spelling words that are entered via the virtual keyboard application. In this case the, the set of keys in the third window may comprise the keys that are most commonly selected after the key from the second window is selected.

Optionally at 209, the second window may be deactivated. This may be in response to displaying a third window. By deactivating the second window, the set of keys displayed on the second window may no longer be selected. This deactivation may be indicated by changing the color or shading of the first set of keys or the entire second window.

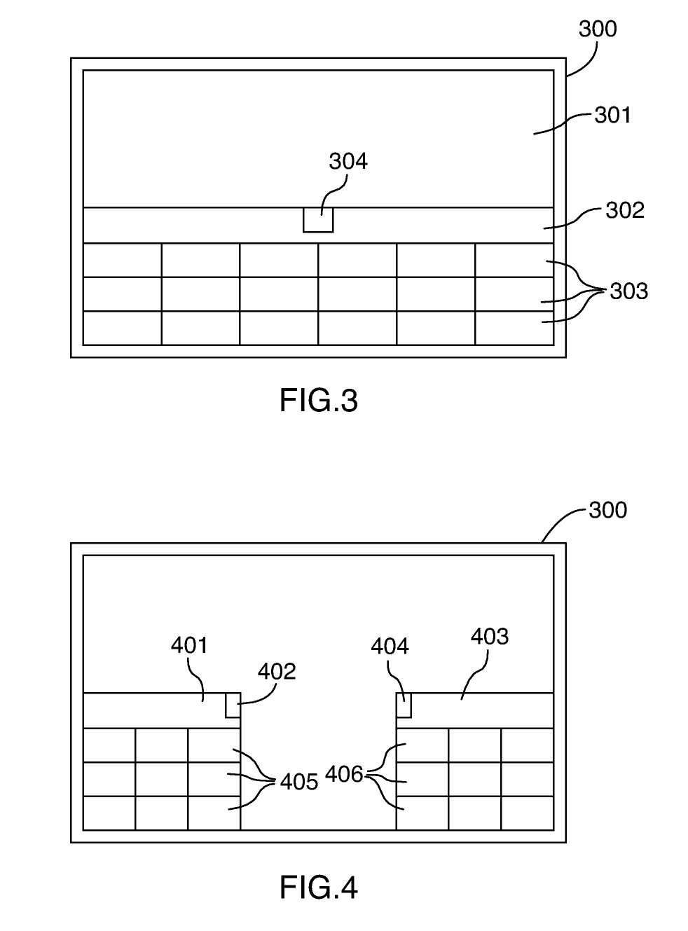

FIG. 3 is a diagram of a touch sensitive device configured to display output of a virtual keyboard in accordance with the disclosure. The touch sensitive device 300 includes a display 301 that shows the output of a virtual keyboard application in a window 302. The output of the virtual keyboard application includes a control 304 and set of keys 303. The control 304 is used to split and resize one or more of the windows of the virtual keyboard application, as described below.

The set of keys 303 act as a virtual counterpart to keys of a physical keyboard. As a user of the device 300 touches the keys 303, the virtual keyboard application converts the touch events generated by device 300 detecting various touches of device 300 into character inputs that are treated much like the presses on keys of a physical keyboard. In other words, when a user presses down on a key 303 and then lifts up, the character related to that key 303 is then treated as an input to applications running on the device as if a physical key had been pressed on a physical keyboard connected to the device

FIG. 4 is a diagram of a touch sensitive device of FIG. 3, configured to display output of a virtual keyboard in accordance with the disclosure. The output of the virtual keyboard application is now comprised by windows 401 and 403.

Window 401 includes control 402 and set of keys 405. Window 403 includes control 404 and set of keys 406. As compared to the output of the virtual keyboard application in FIG. 3, the virtual keyboard in FIG. 4 has been split and resized. This may be performed by a user touching the display of the touch sensitive device where control 304 is located and moving the touch over to where control 404 is located. In this case, the differences between a touch down event corresponding to where control 304 is located and a touch up event corresponding to where control 404 is located to provide the basis for resizing the output of the virtual keyboard. Further manipulations of controls 402 and 404 may continue to change the size of the output of the virtual keyboard application.

Manipulations of control 402 may continue to change the size of window 401 and also change the size of window 403. Similarly, manipulations of control 404 may continue to change the size of window 403 and also change the size of window 401.

As the virtual keyboard application is resized, the keys displayed within the windows of the virtual keyboard application may be resized proportional to the resizing of the virtual keyboard application. In other words, if a height of the virtual keyboard application is increased, then a height of the individual keys may also be increased. Similarly, if a width of a window of the virtual keyboard application is decreased, then a width of the keys may also be decreased.

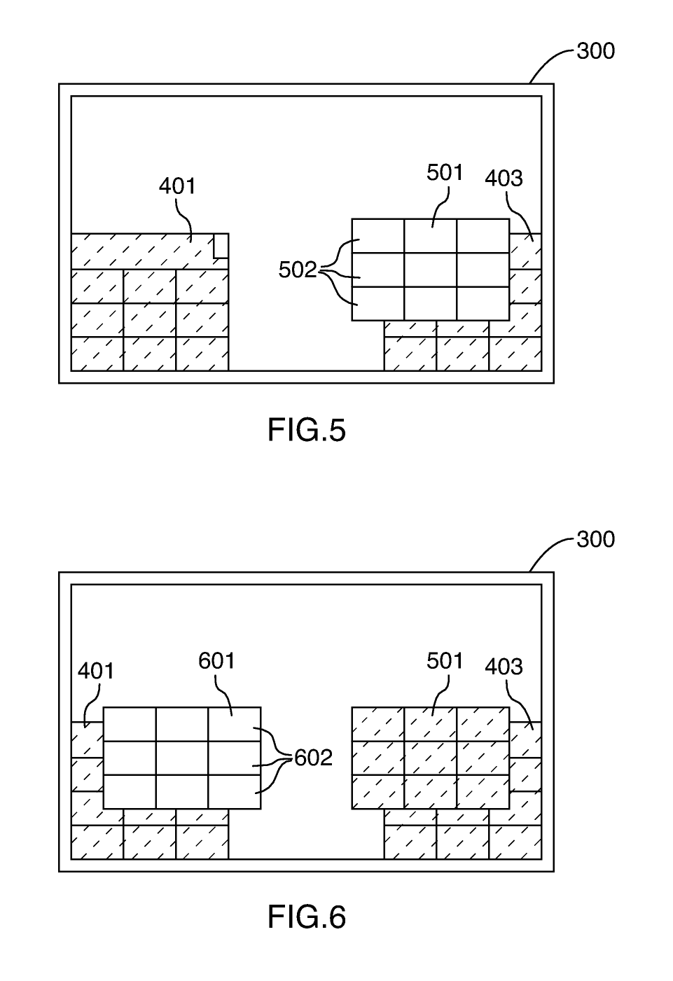

FIG. 5 is a diagram of a touch sensitive device of FIG. 3, configured to display output of a virtual keyboard in accordance with the disclosure. The output of the virtual keyboard application is now comprised by windows 401, 403, and 501.

Windows 401 and 403 have had their color or shading changed so as to indicate that the keys within windows 401 and 403 are no longer able to be used as input. Window 501 is displayed on top of window 403 and includes a set of keys 502. The set of keys 502 are based at least in part on which key from window 401 has been previously selected. For example, if a key selected from window 401 corresponds to the letter ‘A’, then the set of keys 502 may include the letters that are most commonly selected after the letter ‘A’ has been selected, including the letter ‘T’.

FIG. 6 is a diagram of a touch sensitive device of FIG. 3, configured to display output of a virtual keyboard in accordance with the disclosure. The output of the virtual keyboard application is now comprised by windows 401, 403, 501, and 601.

Windows 401, 403, and 501 have had their color or shading changed so as to indicate that the keys within windows 401, 403, and 501 are no longer able to be used as input. Window 601 is displayed on top of window 401 and includes a set of keys 602. The set of keys 602 are based at least in part on which key from window 501 has been previously selected. For example, if a key selected from window 501 corresponds to the letter ‘T’, then the set of keys 602 may include the letters that are most commonly selected after the letters ‘A’ and ‘T’ have been selected, including the letter ‘H’. Additional windows may be continued to be displayed on top of prior windows until a word has been spelled out.

In alternative embodiments, windows 501 and 601 may be displayed in substantially the same portion of the display 301. For example, if a letter ‘A’ is selected from a first window (e.g., window 401), a second (or third) window may be displayed on top of the first window. Similarly, if a letter ‘T’ is selected from the second window on top of the first window, a third (or fourth) window may be displayed on top of both the first and second windows.

Code adapted to provide the systems and methods described above may be provided on many different types of computer-readable media or mediums, including computer storage mechanisms (e.g., CD-ROM, diskette, RAM, flash memory, computer hard drive, etc.) that tangibly embody software instructions for use in execution by one or more processor to perform the methods and implement the apparatus described herein.

The systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that steps and the order of the steps in the processing described herein may be altered, modified and/or augmented and still achieve the desired outcome.

1. A method of a touch sensitive device for displaying one or more keys of a virtual keyboard on one or more windows of a graphical user interface of the touch sensitive device, the method comprising:
displaying a first set of the one or more keys on a first window of the one or more windows;
receiving a first touch event comprising a plurality of first touch values;
receiving a second touch event comprising a plurality of second touch values associated with a touch detected by the touch sensitive device; and
displaying a second set of the one or more keys on a second window of the one or more windows based at least in part on the second touch event.

2. The method of claim 1, wherein the size of the second window is associated with the size of the first window.

3. The method of claim 1, wherein the displaying a second set of the one or more keys on a second window occurs when at least one threshold is met by at least one difference between the first touch values and the second touch values.

4. The method of claim 3, wherein
the at least one threshold includes one of a time threshold and a diagonal threshold,
the time threshold is met by a time difference between the first touch values and second touch values, and
the diagonal threshold is met by at least one location difference between the first touch values and the second touch values.

5. The method of claim 4, wherein the time difference is a difference between a first time value of the first touch values and a second time value of the second touch values and the at least one location difference is a difference between at least one first location value of the first touch values and at least one second location value of the second touch values.

6. The method of claim 1, wherein the second touch value includes a type and the type is that of one of a move event and a touch up event.

7. The method of claim 1, wherein the one or more keys comprised by the second set is based at least in part on one of the one or more keys that is associated with the first touch event.

8. The method of claim 1, further comprising:
deactivating the first window when the second window is displayed, wherein the deactivating comprises changing a color of the first set of the one or more keys.

9. The method of claim 7, further comprising:
receiving a third touch event comprising a plurality of third touch values;
displaying a third set of the one or more keys on a third window of the one or more windows based at least in part on the third touch event; and
deactivating the first window and the second window when the third window is displayed, wherein the deactivating comprises changing a color of the first set and the second set of the one or more keys;
wherein the one or more keys comprised by the third set is based at least in part on one of the one or more keys comprised by the second set that is associated with the second touch event.

10. The method of claim 9, wherein the third window is displayed on top of one of the first window and the second window.

11. A an apparatus comprising:
a display;
one or more touch sensors; and
one or more processors configured to:
display a first set of the one or more keys on a first window of the one or more windows;
receive a first touch event comprising a plurality of first touch values;
receive a second touch event comprising a plurality of second touch values associated with a touch detected by the touch sensitive device; and
display a second set of the one or more keys on a second window of the one or more windows based at least in part on the second touch event.

12. The apparatus of claim 11, wherein the size of the second window is associated with the size of the first window.

13. The apparatus of claim 11, wherein the displaying a second set of the one or more keys on a second window occurs when at least one threshold is met by at least one difference between the first touch values and the second touch values.

14. The apparatus of claim 11, wherein the one or more keys comprised by the second set is based at least in part on one of the one or more keys that is associated with the first touch event.

15. The apparatus of claim 14, further comprising:
receiving a third touch event comprising a plurality of third touch values;
displaying a third set of the one or more keys on a third window of the one or more windows based at least in part on the third touch event; and
deactivating the first window and the second window when the third window is displayed, wherein the deactivating comprises changing a color of the first set and the second set of the one or more keys;
wherein the one or more keys comprised by the third set is based at least in part on one of the one or more keys comprised by the second set that is associated with the second touch event; and
wherein the third window is displayed on top of one of the first window and the second window.

16. A computer readable medium bearing code which, when executed, causes a computing device to:
display a first set of the one or more keys on a first window of the one or more windows;
receive a first touch event comprising a plurality of first touch values;
receive a second touch event comprising a plurality of second touch values associated with a touch detected by the touch sensitive device; and
display a second set of the one or more keys on a second window of the one or more windows based at least in part on the second touch event.

17. The computer readable medium of claim 16, wherein the size of the second window is associated with the size of the first window.

18. The computer readable medium of claim 16, wherein the displaying a second set of the one or more keys on a second window occurs when at least one threshold is met by at least one difference between the first touch values and the second touch values.

19. The computer readable medium of claim 16, wherein the one or more keys comprised by the second set is based at least in part on one of the one or more keys that is associated with the first touch event.

20. The computer readable medium of claim 19, further causing the computing device to:
receiving a third touch event comprising a plurality of third touch values;
displaying a third set of the one or more keys on a third window of the one or more windows based at least in part on the third touch event; and
deactivating the first window and the second window when the third window is displayed, wherein the deactivating comprises changing a color of the first set and the second set of the one or more keys;
wherein the one or more keys comprised by the third set is based at least in part on one of the one or more keys comprised by the second set that is associated with the second touch event; and
wherein the third window is displayed on top of one of the first window and the second window.

21-35. (canceled)
